(19) United States
(12) Patent Application Publication
(10) Pub. No.: US 2016/0053899 A1
(43) Pub. Date: Feb. 25, 2016

(54) VALVE WITH WELDED DIAPHRAGM TO ASSIST OPENING FORCE

(71) Applicant: Swagelok Company, Solon, OH (US)

(72) Inventors: William H. Glime, Chagrin Falls, OH (US); Timothy Garrett Gray, Painesville, OH (US)

(21) Appl. No.: 14/828,642

(22) Filed: Aug. 18, 2015

Related U.S. Application Data
(60) Provisional application No. 62/039,543, filed on Aug. 20, 2014.

(51) Int. Cl. F16K 7/14; F16K 27/02

(52) U.S. Cl. CPC F16K 7/14; F16K 27/0236

(57) ABSTRACT

A springless diaphragm valve and associated diaphragm have increased lifting force for opening the valve. In an embodiment, the diaphragm is a diaphragm assembly of a domed diaphragm having a surface that contacts the valve seat to close the valve, and a biasing member which may also be a domed diaphragm. The diaphragm has a central portion that is attached to the biasing member, for example by a weld. The diaphragm and the biasing member may be nested together, and each may be circular and include a domed portion. The weld is preferably in a central portion of the diaphragm near the apex or geometric center of the diaphragm.

### RELATED APPLICATION

The present application claims the benefit of pending U.S. Provisional Patent Application Ser. No. 62/039,543 filed on Aug. 20, 2014 for VALVE WITH WELDED DIAPHRAGM TO ASSIST OPENING FORCE, the entire disclosure of which is fully incorporated herein by reference.

### TECHNICAL FIELD OF THE INVENTIONS

The inventions relate to fluid flow and delivery devices and methods, and more particularly to diaphragm valves used to control fluid flow and delivery.

### BACKGROUND OF THE INVENTIONS

Diaphragm valves are well known for use as flow control devices for gas and liquid fluid delivery. In the semiconductor industry as well as others, delivery of process chemicals during various processing operations is controlled using valves, for example, high purity diaphragm valves. Some of the more common applications for diaphragm valves are chemical vapor deposition (CVD) and atomic layer deposition (ALD).

### SUMMARY OF THE INVENTIONS

A first inventive concept presented herein provides a diaphragm valve with a biasing member or device that applies a lifting force to the diaphragm. In an embodiment, the diaphragm comprises a biasing member that is welded preferably to a central area of the diaphragm. Additional embodiments of this concept are presented herein.

A second inventive concept presented herein provides a diaphragm for a diaphragm valve with the diaphragm comprising a biasing member or device that applies a lifting force to the diaphragm. In an embodiment, the diaphragm comprises a biasing member that is welded preferably to a central area of the diaphragm. Additional embodiments of this concept are presented herein.

A third inventive concept presented herein provides a diaphragm for a diaphragm valve with the diaphragm comprising a biasing member or device that applies a lifting force to the diaphragm. In an embodiment, the diaphragm comprises a domed diaphragm and the biasing member or device is welded preferably to a central area of the domed diaphragm. Additional embodiments of this concept are presented herein.

A fourth inventive concept presented herein provides a diaphragm valve with a biasing member or device that applies a lifting force to the diaphragm. In an embodiment, the diaphragm comprises a domed diaphragm and the biasing member or device is welded preferably to a central area of the domed diaphragm. Additional embodiments of this concept are presented herein.

A fifth inventive concept presented herein provides a method to increase the opening force on a diaphragm in a diaphragm valve. In an embodiment, the method comprises the step of welding or otherwise attaching a biasing member or device to a preferably central area of the diaphragm. Additional embodiments of this concept are presented herein.

A sixth inventive concept presented herein provides a diaphragm valve with a biasing member or device that applies a lifting force to the diaphragm. In an embodiment, the diaphragm comprises a biasing member or device that is attached preferably to a central area of the diaphragm. Additional embodiments of this concept are presented herein.

A seventh inventive concept presented herein provides a diaphragm for a diaphragm valve with the diaphragm comprising a biasing member or device that applies a lifting force to the diaphragm. In an embodiment, the diaphragm comprises a domed diaphragm and the biasing member or device is attached preferably to a central area of the domed diaphragm. Additional embodiments of this concept are presented herein.

An eighth inventive concept presented herein provides a diaphragm for a diaphragm valve with the diaphragm comprising a biasing member or device that applies a lifting force to the diaphragm. In an embodiment, the diaphragm comprises a biasing member that is attached preferably to a central area of the diaphragm. Additional embodiments of this concept are presented herein.

Another inventive concept presented herein provides a domed diaphragm for a diaphragm valve with structure that applies a lifting force of the diaphragm. In an embodiment, the domed diaphragm comprises a single sheet of metal having an upper or non-wetted surface structure that increases lifting force of the domed diaphragm compared to the diaphragm without the structure. Additional embodiments of this concept are presented herein.

In the exemplary embodiments herein, the diaphragm valve preferably is a springless diaphragm valve that uses a domed diaphragm or two or more stacked domed diaphragms.

These and other inventive concepts are fully disclosed hereinbelow, and will be readily understood by those skilled in the art from the following detailed description of the exemplary embodiments in view of the accompanying drawings.

### BRIEF DESCRIPTION OF THE DRAWINGS

FIG. 1 illustrates an embodiment of a springless diaphragm valve in accordance with the disclosed teachings herein and illustrated in the valve closed condition,

FIG. 2 is an enlarged cross-section of a prior art diaphragm stack of two diaphragms for a diaphragm valve, shown with flow blocked,

FIG. 3 is a cross-section illustration of a welded diaphragm according to the inventions and teachings herein,

FIG. 4 is an illustration in plan of the welded diaphragm of FIG. 3,

FIGS. 5A-5D illustrate representations various examples of a weldment in cross-section that may be used used with the diaphragm of FIGS. 3 and 4,

FIG. 6 is a chart of lifting force versus stroke comparing a traditional single domed diaphragm with a welded diaphragm and biasing member embodiment disclosed herein,

FIG. 7 is an isometric of an alternative embodiment of a domed diaphragm having segmented portions,

FIG. 8 is an isometric of an alternative embodiment of a domed diaphragm having a biasing member in the form of a strip of material attached to the diaphragm,

FIGS. 9A/9B are an exploded and assembled isometrics of an alternative embodiment of a domed diaphragm having a biasing member in the form of a disc spring attached to the diaphragm.

### DESCRIPTION OF EXEMPLARY EMBODIMENTS

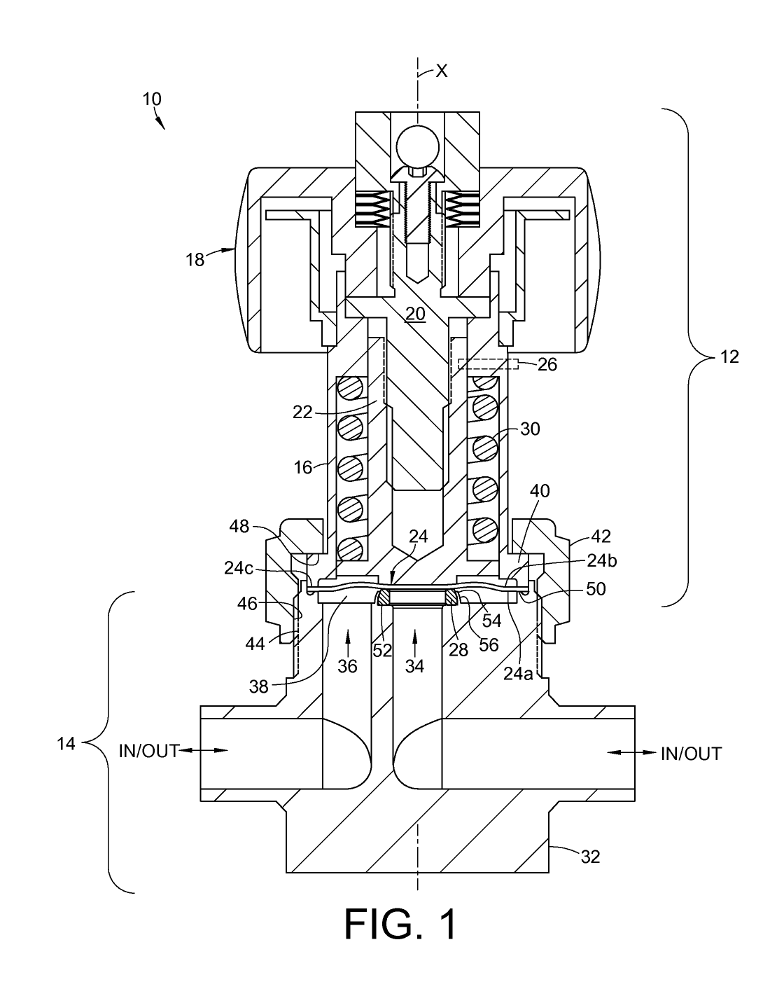

With reference to FIG. 1, in an exemplary embodiment, a valve and actuator assembly 10 may include an actuator assembly 12 and a valve assembly 14. The actuator assembly 12 may be stacked on top of the valve assembly 14 or otherwise operably coupled therewith to open and close the valve. Although this exemplary embodiment illustrates use of a manual actuator, alternative embodiments may use automatic actuators, for example a pneumatic actuator. The valve assembly 14 may be used to control flow of a fluid such as liquid or gas.

The actuator assembly 12 and the valve assembly 14 may be but need not be conveniently realized as a DP Series or a DF Series springless diaphragm valve, which is available commercially from Swagelok Company, Solon, Ohio. The DP Series and DF Series valves are also shown in the product catalogs titled SPRINGLESS DIAPHRAGM VALVES and HIGH FLOW SPRINGLESS DIAPHRAGM VALVES which are publicly available online and otherwise from Swagelok Company, and are fully incorporated herein by reference. However, many other actuator designs and diaphragm valve designs may alternatively be used.

The actuator assembly 12 for convenience may be an actuator assembly that is sold commercially with the DP Series or DF Series diaphragm valves. Therefore, a detailed explanation of the actuator assembly 12 is not necessary to understand and practice the present inventions. The configuration in the drawings is for a manual actuator assembly, but alternatively the valve and actuator assembly 10 may be practiced with automatic actuator, for example, a pneumatic or hydraulic or electromechanical actuator.

The exemplary actuator assembly 12 includes bonnet 16 and a handle 18 that is supported on the bonnet 16 and can be rotated relative thereto. The handle 18 may be turned manually to open and close the valve assembly 14. The handle 18 is operably coupled to a drive member 20 so that rotation of the handle causes rotation of the drive member 20. The drive member 20 is threadably coupled to a valve stem 22. The valve stem 22 contacts a non-wetted side (24b) of a diaphragm 24. Although due to scale it is not discernible in FIG. 1, the diaphragm 24 preferably comprises a diaphragm and a biasing member, for example a second diaphragm or other structure, as further explained hereinbelow. A set screw 26 restricts the valve stem 22 from turning with the actuator stem 20. As a result, rotation of the actuator stem 20 causes axial displacement of the valve stem 22 up and down depending on the direction that the handle 18 is rotated. The valve 14 is shown in FIG. 1 in a closed position. In order to close the valve 14, the handle 18 is turned clockwise as viewed in the drawing which causes the actuator stem 20 to rotate clockwise which in turn causes the valve stem 22 to translate axially downward so as to press the diaphragm 24 against a valve seat 28. The diaphragm 24 may include a surface 24a that is pressed into contact with the valve seat 28 in order to close the valve 14 (this is the condition illustrated in FIG. 1). In the exemplary embodiments herein, the surface 24a is a concave surface because the diaphragm 24 is preferably a domed diaphragm. The surface 24a that contacts the valve seat is exposed to the working fluid that flows through the valve 14 and is also referred to herein as the wetted surface 24a. A spring 30 is provided and applies a closing force to the valve stem 22. This limits the closing force applied to the diaphragm 24 as a function of the spring force to thereby prevent over-tightening of the handle 18 from damaging the valve seat 28. When the handle 18 is turned in order to close the valve 14, the valve stem 22 pushes against the top of the diaphragm 24. The upper side of the diaphragm 24 (which is a convex surface for a domed diaphragm) is not exposed to the working fluid and therefore is referred to as a non-wetted side 24b of the diaphragm.

In order to open the valve 14, the handle 18 is turned counterclockwise as viewed in the drawing. This causes the actuator stem 20 to turn counterclockwise which causes the valve stem 22 to translate axially upward which, in the example of a domed diaphragm, allows the diaphragm 24 to return to its natural domed shape with the concave wetted surface 24a separating from the valve seat 28 thereby opening the valve 14 to flow.

The diaphragm 24 preferably may be domed to have a spring-like effect in that the natural unstressed state of the diaphragm 28 is to return to its domed curved shape (meaning the wetted side 24a is concave). The diaphragm 24 may be made of any material that is suitable for the working fluid that flows through the valve 14. For example, the diaphragm 24 may be made entirely of stainless steel, but other materials may be used as needed for particular applications including non-metal diaphragms, or the diaphragm may include portions made of different materials. Suitable materials for the diaphragm 24 (and the biasing member described below) include but are not limited to Elgiloy, MP35N, stainless steel, Hastalloy, to name a few examples. However, the inventions are not limited to metal diaphragms and may also be used with plastic diaphragms or composite diaphragms, for example, diaphragms that use a mix of plastic and metal, different metals, or composite materials such as ceramics and so on.

The diaphragm valve 14 is commonly known as a springless diaphragm valve, because the diaphragm 24 returns to a natural unstressed condition or shape due to its inherent spring-like action without the need for the actuator assembly 12 to apply a force (such as through a spring or otherwise) to move the diaphragm 24 in order to open the valve 14. This is in contrast to a tied diaphragm style valve in which the diaphragm is attached to the valve stem so that movement of the valve stem forces movement of the diaphragm and it is the valve stem, not a surface of the diaphragm, that contacts the valve seat in order to close the valve. In a springless diaphragm valve as described herein, the valve stem and the diaphragm are not attached or otherwise connected together to each other.

The valve assembly 14 includes a valve body 32 and may have two or more ports for fluid flow through the valve body. The valve body 32 has a longitudinal axis X that is coaxial with a centerline of the valve seat 28. The axis X may be but need not be a center longitudinal axis of the valve body 32. All references herein to axial and radial alignment or directions are referenced to the axis X unless otherwise noted herein. Reference herein to directional movement, such as for example upward and downward, are for convenience of explanation with the drawings but do not require a particular orientation or alignment of the valve 14 relative to the axis X.

The valve body 32 may include a first or inlet port 34 (also referred to herein as the inlet) and a second or outlet port 36 (also referred to herein as the outlet) both of which are in fluid communication with a valve cavity 38 when the valve is open. The valve seat 28 surrounds the inlet port 34. The valve cavity 38 is sealed by the diaphragm 24 and the valve seat 28. When the diaphragm 24 is downwardly deflected (as viewed in the drawings and particularly FIG. 1) by downward movement of the valve stem 22, the wetted surface 24a of the diaphragm is pressed against the valve seat 28 and flow is blocked between the inlet port 34 and the outlet port 36. When the valve stem 22 is moved upwardly (as viewed in the drawings), the closing load applied by the valve stem 22 against the non-wetted side 24b diaphragm 24 is reduced such that the diaphragm 24 may return towards the natural unstressed state, which preferably is a domed shape, with a spring-like action. This spring-like action of the domed diaphragm 24 is also referred to herein as the lifting force of the diaphragm 24, with the lifting force being an inherent characteristic of the domed diaphragm 24 to assist the domed diaphragm 24 to lift away from the valve seat 28 and return to the natural unstressed condition of the diaphragm 24. Whether the diaphragm is permitted to fully return to a fully unstressed condition is a matter of design choice, but it is preferred to maximize fluid flow. But, alternatively, the diaphragm 24 may return to a condition that is less than fully unstressed but nonetheless unblocks fluid flow between the inlet and outlet of the diaphragm valve 14. The domed diaphragm 24, which may deformed into a somewhat flattened profile (see FIG. 1) when the valve stem 22 forces the diaphragm against the valve seat 28, acts with a spring force or lifting force that returns the diaphragm 24 to the unstressed domed profile (see FIG. 3) and out of contact with the valve seat 28. This relaxation of the diaphragm 24 to its natural unstressed state results in the diaphragm wetted surface 24a being moved out of contact with the valve seat 28 so that the inlet port 34 and the outlet port 36 are in fluid communication with each other through the valve cavity 38. Additional ports may be provided as needed. Fluid flow may be in either direction between the first port 34 and the second port 36 so that the reference herein to an inlet port 34 and an outlet port 36 is for convenience of description only.

A distal end 16a of the bonnet opposite the handle 18 end includes a flange 40. A bonnet nut 42 may be used to clamp and hold the bonnet 16 on the valve body 32. For example, the valve body 32 may include a threaded portion 44 that mates with a threaded portion 46 of the bonnet nut 42. The bonnet nut 42 also includes a flange 48 that engages the flange 40 of the bonnet so that when the bonnet nut 42 is tightened down onto the valve body the bonnet flange 40 is captured and axially loaded between the bonnet nut flange 48 and a clamping surface 50 of the valve body 32. An outer peripheral portion 24c of the diaphragm 24 that is preferably flat or planar, and also preferably has a circumference defined as a circle, may be clamped between the bonnet flange 40 and the clamping surface 50 of the valve body 32. This provides a body seal that seals the valve cavity 38 against fluid loss to the ambient environment. The domed portion (110 in FIG. 3) is circumferentially surrounded by the outer peripheral portion 24c. The domed portion (110) therefore extends in a curved fashion out of the plane of the peripheral portion 24c. The diaphragm 24 thus presents the wetted surface 24a, which for a domed diaphragm is a concave surface, that faces the valve seat 28; and a non-wetted surface 24b, which for a domed diaphragm is a convex surface, that faces the valve stem 22.

The valve seat 28 may be disposed in a valve seat recess 52 of the valve body 32. The valve seat recess 52 surrounds the inlet port 34 and may include an annular support wall 54 that delimits the valve seat recess 52. The annular support wall 54 may be inwardly and optionally staked as shown so as to capture and secure the valve seat 28 in the valve seat recess 52. Thus, the support wall 54 when staked presents a tapered frusto-conical outer surface 56.

The valve assembly 14 may be made of many different materials. The DP Series and DF Series include valve bodies and diaphragms made of stainless steel. The valve seat 28 is commonly made of non-metal materials, for example, including but not limited to PFA (perfluoalkoxy), PTFE, (polytetrafluoroethylene), PCTFE (polychlorotrifluoroethylene), PEEK (polyetheretherkeytone), PI (polyimide), and elastomers.

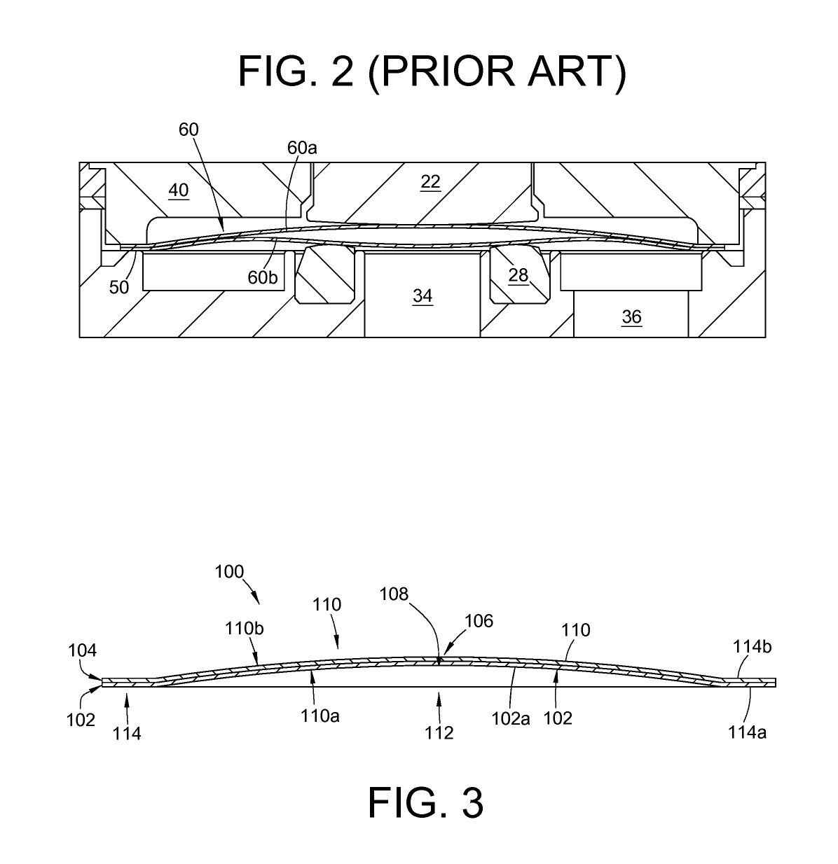

FIG. 2 illustrates an example of a traditional stacked domed diaphragm assembly 60 having a first or upper domed diaphragm 60a and a second or lower domed diaphragm 60b (the second diaphragm 60b is the wetted diaphragm), according to the prior art, shown in cross-section. Because the diaphragm assembly 60 is clamped at its periphery by the bonnet flange 40 and the valve body clamping surface 50, the domed diaphragm assembly 60 will undergo a spring force to return to its unstressed state when the actuator closing force or load is removed. The each diaphragm of the domed diaphragm assembly 60 may have a thickness of 0.004 in. to 0.005 in. for a diaphragm of a one inch diameter, for lower pressure valves, for example.

We show the diaphragm assembly 60 in FIG. 2 as installed and under a condition in which the actuator closing force has been removed from the diaphragm assembly 60 in order to open the valve. But, the diaphragms as shown and particularly the domed portions can move separately so that the upper diaphragm 60a lifts away due to its inherent spring force, but the lower diaphragm 60b can become stuck to or otherwise held against the valve seat 28 so that the valve cannot open. The prior art provides diaphragms that may be either a single sheet or layer of metal, for example stainless steel, or multi-layer or multiple sheets of metal. For example, two or more diaphragms may be vertically stacked on top of each other, in a multiple diaphragm design. In the prior art multiple diaphragm design such as FIG. 2, the diaphragm assembly 60 includes two or more diaphragms that are stacked or nested together. The stacked diaphragms may also be welded at their peripheral edges, however, the individual diaphragms are otherwise free to slide and shift relative to each other particularly in the region of the domed portions to facilitate flexure of the individual diaphragms when the diaphragms are deformed in order to close the valve.

In a multiple diaphragm design, the innermost diaphragm faces the valve seat and is the only diaphragm that contacts the valve seat to close the valve. When the valve stem closing force is removed in order to open the valve, all of the diaphragms in the stack must return to their unstressed domed condition. However, the innermost diaphragm can become stuck to the valve seat (for example, due to chemical interaction with the fluid, or pressure or temperature effects) or may be held against the valve seat when the valve is used in a vacuum application (i.e. the downstream pressure is negative relative to the upstream pressure). This effect of the innermost diaphragm becoming stuck in the closed position (FIG. 2) can occur because the other diaphragms in the diaphragm stack are free to return to their unstressed condition, even if the peripheral edges of the stack are attached together such as by a weld. As a result, a higher opening or lifting force is needed initially to move or release the innermost diaphragm away from the valve seat in order to return to the innermost diaphragm to its unstressed condition.

With reference to FIGS. 3-5, in an embodiment of the teachings and inventions herein, the prior art diaphragm 60 (FIG. 2 only) is replaced with a diaphragm assembly 100 (which may correspond to the diaphragm 24 in FIG. 1) which in an embodiment includes a diaphragm 102 and a biasing member 104 that is attached or connected to the diaphragm 102. By biasing member 104 is meant a structure or device that is attached to the diaphragm 102 wherein the diaphragm 102 has a surface 102a that contacts the valve seat 28 to close the valve 14 (i.e. to block flow between the inlet and the outlet). Therefore, as an example, in a multiple diaphragm stack, the biasing member is attached, preferably by a direct attachment, to the innermost diaphragm that faces the valve seat 28 (where two or more diaphragms are used, the biasing member 104 may be attached to all of the diaphragms).

The biasing member 104 increases the opening or lifting force for the diaphragm 102 in order to assist the diaphragm 102 to return or move towards its natural unstressed condition. Stated another way, the biasing member 104 applies a lifting force to the diaphragm 102 to which the biasing member 104 is attached. This lifting force of the biasing member 104 is preferably additive to the inherent lifting force of the diaphragm 102 away from the valve seat 28 in order to open the valve 14 to flow. The diaphragm 102 preferably but not necessarily returns to a fully unstressed natural condition when the actuator closing force is removed. The inclusion of the biasing member 104 allows the designer to design a diaphragm valve with the benefits and advantages of a springless diaphragm design. These advantages include among others using thinner diaphragms and diaphragm stacks to increase stroke, cycle life, and to maximize flow. But, using thinner diaphragms reduces the lifting force of the diaphragm, so that the inventions herein provide structure and methods for a diaphragm or diaphragm stack with higher lifting force applied to the diaphragm that contacts the valve seat.

In an embodiment, the diaphragm 102 is preferably a domed diaphragm and may be but need not be a domed diaphragm of known design such as are used with the DF and DP series springless diaphragm valves referenced hereinabove. Although a domed diaphragm is preferred, it is not required to be domed as that term would be understood by those in the art. Other diaphragms may be used alternatively in which due to an applied actuation force, the diaphragm may be deformed or stressed to contact a valve seat to close the valve, but then relaxes or returns to its natural unstressed condition to open the valve when the actuation force is removed from the diaphragm. The exemplary diaphragm 102 may be circular in plan but a circular shaped diaphragm 102 is not require. The diaphragm 102 may alternatively be oval or have a more squared appearance, for example. In a diaphragm stack, the diaphragm 102 is that diaphragm that has a surface 102a that contacts the valve seat 28 in order to close off or block flow through the valve 14. The surface 102a is therefore a wetted surface meaning that the surface 102a is exposed to the working fluid that flows through the valve assembly 14. The biasing member 104 in an embodiment may be a second domed diaphragm. In an exemplary embodiment, a central portion 106 (also referred to herein as a central area) of the diaphragm 102 may be attached to the biasing member 104 by an attachment, for example, in the form of a weld 108. In the exemplary embodiment, the first diaphragm 102 and the biasing member 104 in the form of a second domed diaphragm may be stacked or nested together or otherwise arranged conveniently so as to allow the weld 108 to be provided at the central portion 106 of the first diaphragm 102.

The diaphragm assembly 100 in an embodiment, therefore, preferably is a stack of two or more domed diaphragms with each diaphragm having a main domed portion 110 (indicated as 110a for the diaphragm 102 and 110b for the biasing member 104) that extends radially from a geometric center point 112 of the first diaphragm 102 to a preferably flat peripheral rim 114 (indicated as 114a for the diaphragm 102 and 114b for the biasing member 104 in FIG. 3). The rim 114 need not be flat and preferably may be but need not be a circle in circumference. Each rim 114 provides a stable surface for clamping the respective diaphragm 102, 104 between the bonnet 40 and the valve body clamping surface 50. Other rim geometries may be used as needed depending on the type of clamping arrangement used to secure the diaphragm to the valve body to form a body seal. For example, the rims 114a and 114b may be bent over a corner, or may be welded not only to each other but also to one or more of the clamping surfaces. The domed portions 110a and 110b may be but not necessarily be spherical in form but may alternatively be a curved surface comprising two or more radii.

The central portion 106 of the diaphragm 102 is preferably a surface area that encompasses the geometric center point 112 of the diaphragm 102. Preferably, the weld 108 (or other suitable attachment technique) is positioned within a central portion 106 that approximately has a diameter that is 10% of the diameter of the diaphragm 102 and within which the geometric center point 112 is included. This helps assure that the weld 108 will not be located over an area subjected to elevated sheer stress during deflection of the diaphragm 102 and the biasing member 104. Although it is preferred to weld the diaphragm 102 and the biasing member 104 together at this central portion 106 (and thus close to the center point 112) and more preferably at the center point 112, such may not always be required and other weld sites other than what might be considered a “central” portion 106, or encompassing or at a center point 112 of the diaphragm 102 may be used as needed. Because the effect of the attached biasing member 104 is to produce a lifting force that is additive to the inherent lifting force of the dome diaphragm 102 as it returns to the natural unstressed condition, the attachment such as the weld 108 may undergo sheer stresses. It is preferred but not required, therefore, to design the attachment, for example the weld 108, to be of sufficient size, depth and strength to withstand the stresses induced by the lifting force of the biasing member 104 without compromising the weld 108; but preferably also to have the weld 108 as small as possible so as to reduce the stresses that are induced by the flexure of the diaphragm 102 and the biasing member 104. It is also preferred to minimize the heat affected zone caused by the welding process, particularly on the wetted surface 102a of the diaphragm 102.

It is also preferred although not necessarily required that when a weld is used for the attachment, that the weld 108 geometry be in the form of a circular weld that is completely filled. However, alternatively, the weld 108 geometry may be in the form of a doughnut-shaped or toroidal ring as further explained below.

Alternatives to the preferred use of a weld, the biasing member 104 may be attached to the diaphragm 102 by other techniques as needed, including but not limited to an adhesive, a brazed connection, a mechanical connection (for example a threaded or snapped connection), interlocking surfaces and so on.

The weld 108 preferably is disposed at the apex of the diaphragm 102 domed portion 110a (which may correspond with the geometric center point 112 of the diaphragm 102), which apex is an area or node of reduced sheer stresses between the diaphragm 102 and the biasing member 104 during flexure of the diaphragm 102.

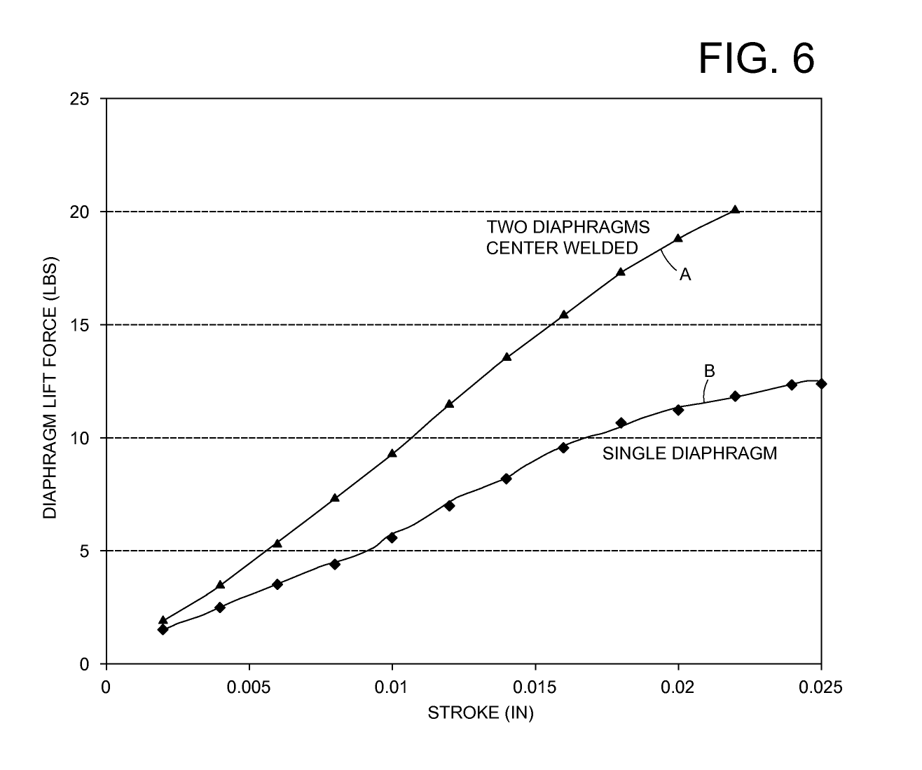

FIGS. 5A-5D illustrate examples of weldment types that may be used for the weld 108, shown in enlarged cross-section, that attaches the diaphragm 102 and the biasing member 104 together. In each embodiment shown, the weld 108 preferably penetrates at least to the centerline 116 of the diaphragm 102 in order to provide holding strength of the weld 108 against the stresses acting on the weld 108 during diaphragm stroke. It is preferred that the weld pool of the weld 108 penetrate into but not entirely through the diaphragm 102. However, in some applications it may be acceptable for the weld 108 to penetrate through the diaphragm 102. Many different welding techniques may be used, including but not limited to laser welding, E-beam welding, single spot penetration weld, resistance spot welding, circular scanned beam welding and so on. A resistance weld is not a penetrating weld, but instead forms at the interface between the two welded members, in this case the diaphragm 102 and the biasing member 104. From the interface, the weld then extends into the diaphragm 102 and the biasing member 104 so that there is minimal or no disruption to the wetted surface 102a of the diaphragm 102.

The welded diaphragm concept as taught herein is particularly advantageous for easy replacement of pre-installed diaphragms in existing diaphragm valves, either diaphragm valves in stock or in the field. This benefit arises from the fact that the diaphragm assembly 100 may be configured to have the same geometry as prior diaphragms or diaphragm stacks for in situ replacement.

We have found that the use of the weld 108 significantly adds to the inherent lifting force of the diaphragm 102 when the actuator force is removed and the diaphragm domed portion 110a returns to the natural unstressed condition. This additive lifting force provided by the basing member 104 is particularly but not exclusively beneficial in diaphragm valves that are exposed to vacuum or negative pressure which could otherwise tend to hold the diaphragm 102 against the valve seat 28 and possibly cause the diaphragm 102 to stick against the valve seat 28 due to the chemical properties of some fluids or other causes.

FIG. 6 is an exemplary chart of diaphragm lifting force in pounds versus diaphragm stroke at the center point 112 of the diaphragm 102. This chart compares a traditional prior art single domed diaphragm, with a welded diaphragm assembly 100 with a diaphragm 102 and the biasing member 104 welded together according to the teachings herein. This chart dramatically shows the increase in lifting force between the inventive centrally welded two stacked diaphragms (graph A) and the traditional single diaphragm (graph B).

Fusing or welding multiple diaphragms together, e.g., by tack-welding, increases the effective opening force. Placing the fusion point in a strategic position, such as at or encompassing a node at the center point of the diaphragm, tends to minimize stress risers in the fused assembly 100 so that the cycle life and diaphragm stroke can be maintained.

Placing the tack-weld in the central portion 106 (e.g. at a low stress node of the deflecting diaphragm 102) of the diaphragm domed portion 110a can be used to maintain both the sealing capability with the valve seat 28 and have minimal impact on cycle life of the diaphragm 102. This also makes the diaphragm assembly 100 a single unit that is easier to install in an error-proof manner for both original build and retrofit/replacement of previously installed diaphragms.

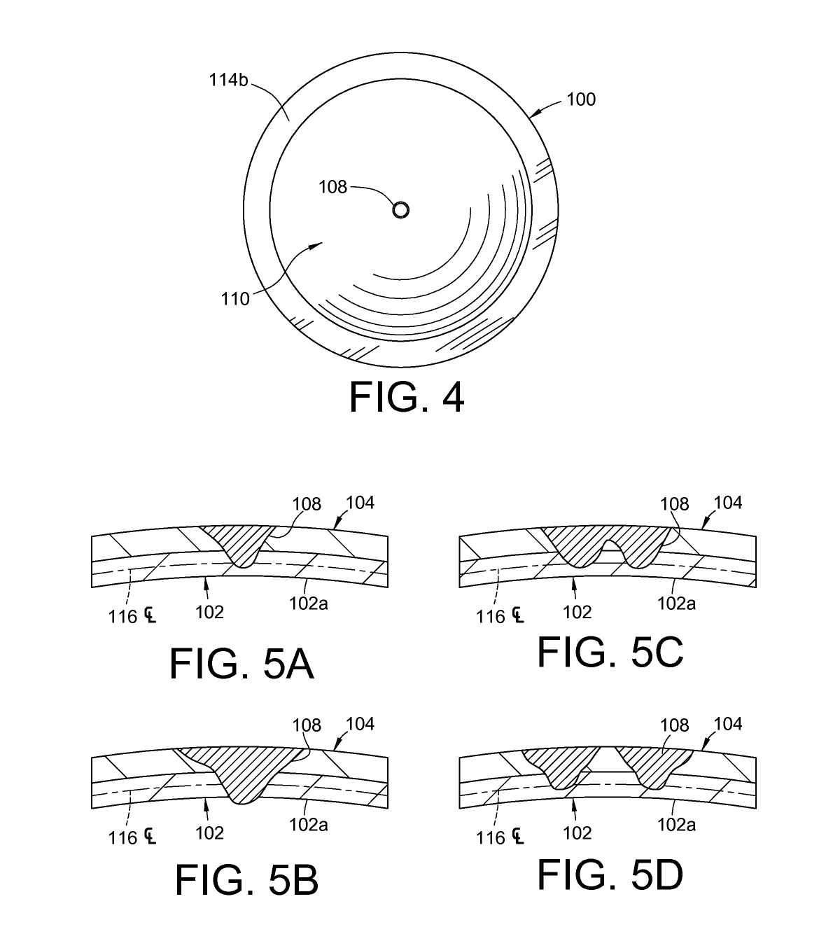

The center tack welded multiple diaphragm stack concept may use a circular weld path for increased weld strength (see FIG. 4 and an exemplary cross-section in FIG. 5D). In this scenario, weld strength is influenced by the width of the weld. In a two dimensional circular weld, this equates to the area of the circle; the larger the circle, the larger the area of the weld interface, leading to a stronger weld. One approach to a larger weld like this would be to increase the spot size of the welding equipment. Depending on the weld process used, this would lead to an increase in welding power in order to reach the power density required to achieve a weld.

In addition to an overall lower welding power delivered by the circular weld path, the penetration depth of the weld can be carefully controlled. A spot weld's penetration profile is dependent on the power delivered to the weld as well as the beams' power profile, in the case of laser or electron beam welders. By using the circular weld path instead of a single spot (see FIG. 5D as an example), weld penetration is determined independently of the weld's overall shape and interface area. This enables control over the appropriate weld penetration, preferably so as to not perforate the wetted surface 102a of the diaphragm 102, as well as achieving a suitable weld area that provides the strength required for the application.

It may seem that a single diaphragm may alternatively be used with a domed portion that has a thicker cross-section as compared with traditional diaphragms. This will also provide an inherently greater spring or lifting force. However, the thicker diaphragm of similar diameter and dome height will exhibit much greater bending stress relative to a traditional thinner diaphragm. This higher stress can lead to either permanent deformation and thus loss of stroke, or lower fatigue life. The inventive concepts and teachings herein avoid the problems that would arise from providing a thicker diaphragm.

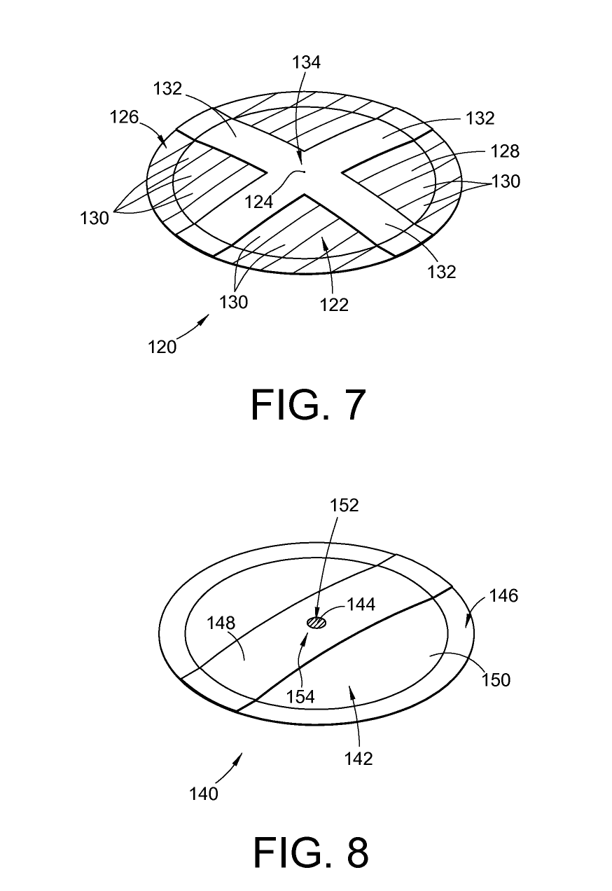

FIGS. 7-8 illustrate additional alternative embodiments for additively increasing the lifting force of a domed diaphragm. In these embodiments, in order to provide additional spring force that assists in returning the diaphragm to its unstressed natural domed shape after the actuator force is released, either the diaphragm itself may include structural modifications of a traditional smooth domed diaphragm, or a traditional smooth domed diaphragm may be provided with additional structural lifting force members or devices.

In the FIG. 7 embodiment, a diaphragm 120 preferably is a domed diaphragm that is circular in plan with the diaphragm having a domed portion 122 that extends radially outward from a center point 124 of the diaphragm 120 to a preferably flattened peripheral rim 126. The rim 126 need not be flat and is preferably a circle in plan. The rim 126 provides a stable surface for clamping the diaphragm 120 between the bonnet 40 and the valve body clamping surface 50 (for the exemplary valve embodiment of FIG. 1). Other rim geometries may be used as needed depending on the type of clamping arrangement used to secure the diaphragm to the valve body to form a body seal as noted hereinabove. The domed portion 122 may be but not necessarily be spherical in form but alternatively may be a curved surface formed of two or more radii.

In an embodiment, a surface 128 of the diaphragm 120, in the illustrated embodiment the convex upper or non-wetted surface, is etched or otherwise scored or modified to provide a structure to increase the lifting force of the diaphragm as compared to a diaphragm that does not have the structure. For example, a structure in the form of a plurality of etched segments 130 (for clarity, not all of the segments 130 are denoted with a lead line) may be provided that increase the flexure of the domed portion 122. Moreover, portions of the surface 128 are not etched, for example, to provide non-etched ribs 132 that extend radially outward preferably from a central portion 134 of the domed portion 122. These non-etched ribs 132 will exhibit a different flexibility than the etched ribs and therefore introduce a spring force that may be used to increase the inherent lifting force of the diaphragm 120. Alternatively, the etching may be applied to the concave wetted surface on the underside of the domed portion 122, which in effect introduces a spring force that acts to push the domed portion 122 back to its unstressed natural domed shape.

In the FIG. 8 embodiment, a diaphragm 140 preferably is a domed diaphragm that is circular in plan with the diaphragm layer having a main domed portion 142 that extends radially outward from a center point 144 of the diaphragm 140 to a preferably flattened peripheral rim 146. The rim 146 need not be flat and preferably is circular in plan. The rim 146 provides a stable surface for clamping the diaphragm 140 between the bonnet 40 and the valve body clamping surface 50 (for the exemplary valve embodiment of FIG. 1). Other rim geometries may be used as needed depending on the type of clamping arrangement used to secure the diaphragm to the valve body to form a body seal as noted hereinabove. The domed portion 142 may be but not necessarily be spherical in form but alternatively may be a curved surface formed of two or more radii.

A biasing member in the form of a separate strip of material 148 overlays a convex non-wetted surface 150 of the domed portion 142 and is preferably although not necessarily attached to the domed portion 142. For example, the strip 148 may be of similar or the same material or a different material as the diaphragm 140 and provides an added stiffness in the nature of a strip spring that provides a lifting force that is additive to the inherent lifting force of the diaphragm 140. For example, the strip 148 may be a thicker piece of material than is used for the diaphragm 140, with the added thickness being determined by the amount of spring force or lifting force needed for the stroke of the diaphragm. Alternatively, the strip or strip spring 148 may be provided on the concave wetted underside surface of the domed portion 142. An exemplary and preferred technique for attaching the strip spring 148 to the diaphragm 140 is a spot weld 152 in a central portion 154 of the domed portion 142 but other attachment locations may alternatively be used as needed. The remaining portion of the strip spring 148 need not be although may be attached to the diaphragm surface. The strip spring 148 preferably extends out to the diaphragm rim 146, and clamped therewith between the valve body and bonnet as described hereinabove,

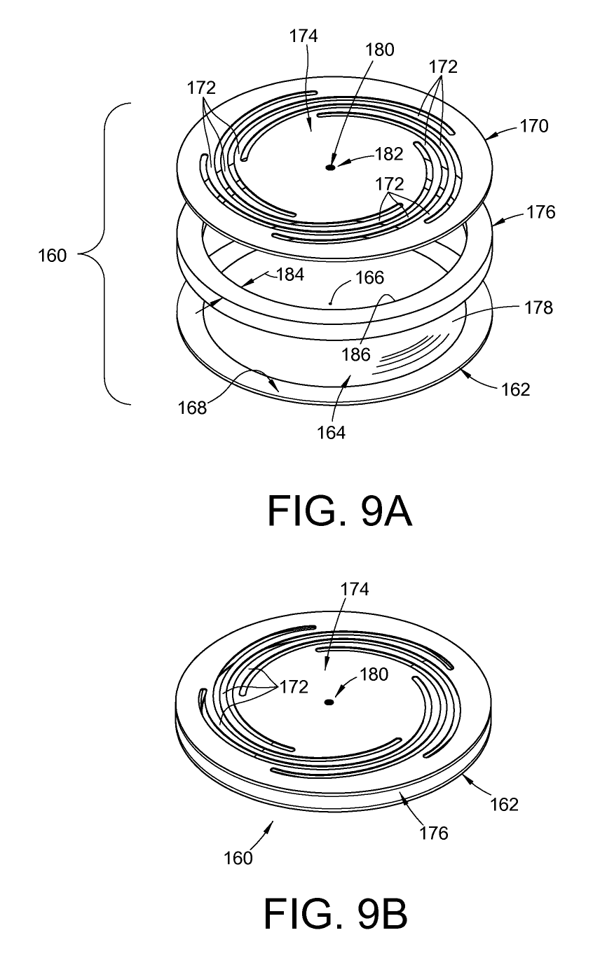

In the FIGS. 9A and 9B alternative embodiment, FIG. 9A is an exploded perspective and FIG. 9B is a perspective of an diaphragm assembly 160. The diaphragm assembly 160 may include a traditional diaphragm 162 that is preferably a domed diaphragm having a main domed portion 164 that extends radially outward from a center point 166 of the diaphragm 162 to a preferably flattened peripheral rim 168. Again, the rim 168 need not be flat. The diaphragm may be and preferably is circular in plan. The domed portion 164 may be but not necessarily be spherical in form but alternatively may be a curved surface formed of two or more radii.

A preferably but not necessarily circular flat disc spring 170 may be formed from a thin sheet of material with various portions etched or cut out so that the remaining form provides a series of segments or legs 172 that allow a central body 174 to flex up and down with a resultant induced spring force. An optional annular spacer 176 may be disposed between the disc spring 170 and the wetted side 178 of the diaphragm 162. Preferably, the spacer 176 and the disc spring 170 have the same outer diameter as the diaphragm 162. An exemplary and preferred technique for attaching the disc spring 170 to the diaphragm 162 is a spot weld 180 to a central portion 182 of the domed portion 164 but other attachment locations may alternatively be used as needed. FIG. 9B shows the completed and welded diaphragm assembly 160. The spacer 176 is preferably annular with a radial width 184 that is comparable or the same as the width of the rim 168. The spacer 176 therefore presents an open central area 186 that allows the flexible legs 172 to be displaced or deflected when the actuator applies force to the disc spring 170 and the diaphragm 162. The disc spring 170, therefore, applies a lifting force that is additive to the inherent lifting force of the diaphragm 162. The spacer 176 preferably allows the disc spring 170 to return to a flat or unstressed condition when the actuator force is removed (e.g. a valve open condition.) This preferably reduces or prevents a downward bias being applied to the domed portion 164 when the domed portion 164 is also in an unstressed condition with the actuator force removed. In an embodiment, the spacer 176 may be dimensioned to have a height that is the same or nearly the same as the height of the domed portion 164. The disc spring 170 and the spacer 176 may alternatively be provided on the wetted side of the diaphragm 162.

A method is also provided to increase lifting force of a diaphragm that is used in a diaphragm valve. In an embodiment, the method includes providing a diaphragm and attaching a biasing member to a central area of the diaphragm. In a preferred embodiment, the biasing member is welded to the diaphragm. In another embodiment, the weldment is formed in an area of the diaphragm that includes a geometric center point of the diaphragm.

It is intended that the inventions not be limited to the particular embodiments disclosed for carrying out the inventions, but that the inventions will include all embodiments falling within the scope of the appended claims.

We claim:

1. A diaphragm valve, comprising:
a valve body having a longitudinal axis and comprising a flow path for fluid from an inlet to an outlet,
a valve seat,
a diaphragm comprising a surface that contacts said valve seat to block flow between said inlet and said outlet, a biasing member attached to said diaphragm, said biasing member being attached to said diaphragm and applies a lifting force to said diaphragm.

2. The diaphragm valve of claim 1 wherein said diaphragm comprises a domed diaphragm.

3. The diaphragm valve of claim 2 wherein said biasing member is welded to said diaphragm.

4. The diaphragm valve of claim 2 wherein said biasing member is attached to a central area of said diaphragm.

5. The diaphragm valve of claim 4 wherein said biasing member is welded to said diaphragm.

6. The diaphragm valve of claim 1 wherein said biasing member is welded to said diaphragm.

7. The diaphragm valve of claim 1 wherein said biasing member is attached to a central area of said diaphragm.

8. The diaphragm valve of claim 7 wherein said biasing member is welded to said diaphragm.

9. The diaphragm valve of claim 1 wherein said biasing member is attached to said diaphragm at a location that includes a central area of said diaphragm.

10. The diaphragm valve of claim 9 wherein said biasing member is welded to said diaphragm.

11. The diaphragm valve of claim 1 in combination with an actuator, said actuator applying a force to said diaphragm to press a wetted surface of said diaphragm against said valve seat.

12. The diaphragm valve of claim 11 wherein said actuator applies said force on an area of said diaphragm where said biasing member is attached to said diaphragm.

13. The diaphragm valve of claim 12 wherein said biasing member is welded to said diaphragm in said area.

14. A diaphragm for a diaphragm valve, comprising:
a surface that contacts a valve seat when used in the diaphragm valve,
a biasing member,
said biasing member being attached to said diaphragm and applies a lifting force to said diaphragm.

15. The diaphragm valve of claim 14 wherein said diaphragm comprises a domed diaphragm.

16. The diaphragm valve of claim 15 wherein said biasing member is welded to said diaphragm.

17. The diaphragm valve of claim 15 wherein said biasing member is attached to a central area of said diaphragm.

18. The diaphragm valve of claim 17 wherein said biasing member is welded to said diaphragm.

19. The diaphragm valve of claim 14 wherein said biasing member is welded to said diaphragm.

20. The diaphragm valve of claim 14 wherein said biasing member is attached to a central area of said diaphragm.

21. The diaphragm valve of claim 20 wherein said biasing member is welded to said diaphragm.

22. The diaphragm valve of claim 14 wherein said biasing member is attached to said diaphragm at a location that includes a central area of said diaphragm.

23. The diaphragm valve of claim 22 wherein said biasing member is welded to said diaphragm.

24. A method to increase opening force of a diaphragm used in a diaphragm valve, comprising:
providing a diaphragm,
attaching a biasing member to a central area of the diaphragm.

25. The method of claim 24 wherein the step of providing a diaphragm includes the step of providing a domed diaphragm.

26. The method of claim 25 wherein the biasing member is welded to the diaphragm in said central area.

27. The method of claim 25 wherein the biasing member is welded to the diaphragm in an area of the diaphragm that includes a geometric center point of the diaphragm.

28. The method of claim 24 wherein the biasing member is welded to the diaphragm in said central area.

29. The method of claim 24 wherein the biasing member is welded to the diaphragm in an area of the diaphragm that includes a geometric center point of the diaphragm.

30. The diaphragm valve of claim 1 wherein said biasing member is attached to said diaphragm at a location that includes a geometric center point of said diaphragm.

31. The diaphragm valve of claim 14 wherein said biasing member is attached to said diaphragm at a location that includes a geometric center point of said diaphragm.
